(19) United States
(12) Patent Application Publication
(10) Pub. No.: US 2023/0281577 A1
(43) Pub. Date: Sep. 7, 2023

(54) CREDIT REDEMPTION PAYMENT SYSTEM

(71) Applicant: inKind Cards, Inc., Austin, TX (US)

(72) Inventor: Bryan Crow, Austin, TX (US)

(21) Appl. No.: 18/116,408

(22) Filed: Mar. 2, 2023

Related U.S. Application Data
(60) Provisional application No. 63/315,963, filed on Mar. 2, 2022.

(51) Int. Cl. G06Q 20/04; G06Q 20/20; G06Q 20/24; G06Q 50/12

(52) U.S. Cl. CPC G06Q 20/042; G06Q 20/20; G06Q 20/24; G06Q 50/12

(57) ABSTRACT

Method starts with processor receiving check number associated with invoice from first client device. Processor identifies line items in invoice associated with payment tender and line items in invoice associated with house credit account of hospitality establishment. Processor causes detailed invoice user interface to be displayed by first client device that comprises payment tender amount due based on line items associated with payment tender, house credit amount due based on line items associated with house credit account, and selectable tip items associated with gratuity amounts. Processor receives selection of first selectable tip item associated with first gratuity amount, computes additional gratuity based on invoice and first gratuity amount, and causes payment review user interface to be displayed by first client device that comprises payment tender charge based on additional gratuity and payment tender amount due, and house credit account charge based on house credit amount due. Other embodiments are disclosed.

### CROSS REFERENCED TO RELATED APPLICATIONS

This claims priority to U.S. Provisional Patent Application Ser. No. 63/315,963, filed Mar. 2, 2022, the contents of which are incorporated herein by reference in their entirety.

### BACKGROUND

Businesses in hospitality, like restaurants, cafes, bars, and nightclubs, can boost their revenue by using advertisements and promotions that offer deals for the consumers. For example, a restaurant can sell a coupon of a given value for food and beverage purchased at their establishment for a lesser amount of money than the given value. Since the cost of the food and beverage costs less than the retail value, the restaurant is still able to generate a profit from the consumer that is redeeming this coupon.

With current client devices, such as smartphones, having constant Internet access, consumers are able to easily access coupons and deals that are offered online as well as redeem their coupons and deals either by showing bar codes or coupon codes to the employees at the establishment.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, in accordance with some examples.

FIG. 2 is a diagrammatic representation of a data structure as maintained in a database, in accordance with some examples.

FIG. 3 is a flowchart for a credit redemption payment process, in accordance with some examples.

FIG. 4A-4B illustrate examples of user interfaces caused to be displayed by the client device 102 during the credit redemption payment process in accordance with one embodiment.

FIG. 5A-5B illustrate examples of user interfaces caused to be displayed by the client device 102 during the credit redemption payment process in accordance with one embodiment.

FIG. 6A-6B illustrate examples of user interfaces caused to be displayed by the client device 102 during the credit redemption payment process in accordance with one embodiment.

FIG. 7A-7B illustrate examples of user interfaces caused to be displayed by the client device 102 during the credit redemption payment process in accordance with one embodiment.

FIG. 8 illustrate an example of a user interface caused to be displayed by the client device 102 during the credit redemption payment process in accordance with one embodiment.

FIG. 9A-9C illustrate examples of user interfaces caused to be displayed by the client device 102 during the credit redemption payment process in accordance with one embodiment.

FIG. 10 is a diagrammatic representation of a machine in the form of a computer system within which a set of instructions may be executed for causing the machine to perform any one or more of the methodologies discussed herein, in accordance with some examples.

FIG. 11 is a block diagram showing a software architecture within which examples may be implemented.

### DETAILED DESCRIPTION

Embodiments of the present disclosure improve the functionality of credit redemption and payment systems that manage credits in food and beverage that have been sold and redeemed by consolidating the purchase and redemption of the food and beverage credit in a single application that further provides updates in near real-time to user interfaces being displayed on client devices. Specifically, the user interfaces can include near real-time updates to the remaining amounts due based on the redeemed credits or other payments by other users on the same invoice as well as near real-time updates to the selectable items associated with amounts of additional tips invoices based on the amount of tip paid by other users on the invoice or the amount of automatic gratuity applied to the invoice.

### Networked Computing Environment

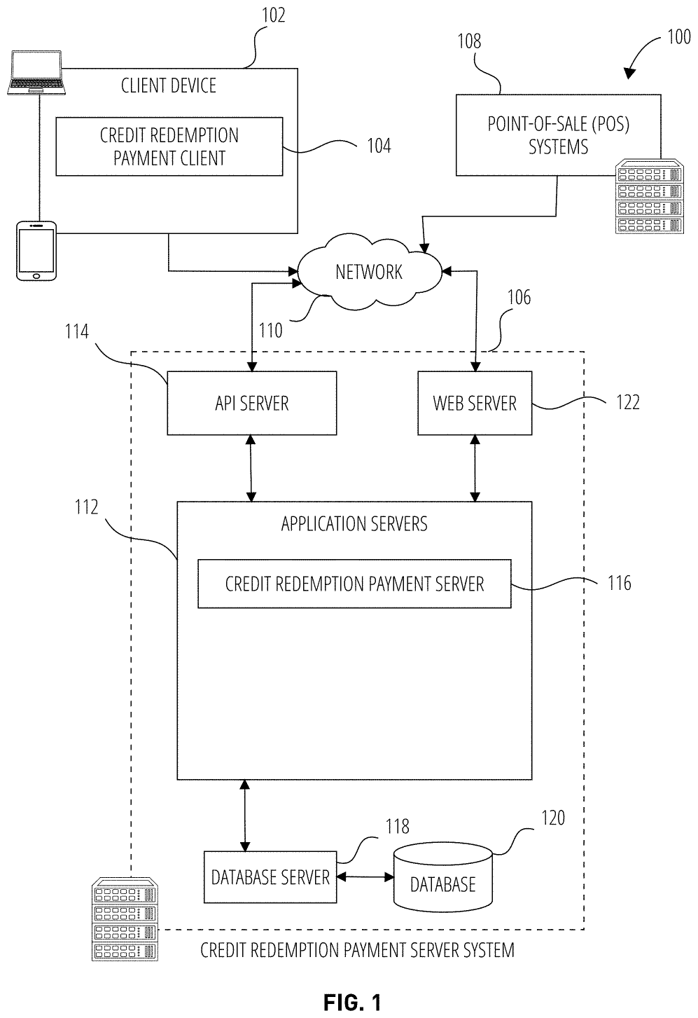

FIG. 1 is a block diagram showing an example system 100 for exchanging data over a network. The system 100 includes multiple instances of a client device 102, each of which hosts a number of applications, including a credit redemption payment client 104, multiple instances of the Point-of-Sale (POS) systems 108, each associated with a hospitality establishment, and a credit redemption payment server system 106 that is communicatively coupled to the client devices 102 and the POS systems 108 via a network 110 (e.g., Internet).

The credit redemption payment server system 106 manages the financing that is provided to a plurality of the hospitality establishments (e.g., restaurants, bars, cafes, nightclubs, etc.) associated with the POS systems 108. Each of the hospitality establishments can be associated with a different financing deal that includes a loan in a given amount of money and an amount of food and beverage credit provided from the hospitality establishments in exchange. The credit redemption payment server system 106 further manages the sale of the food and beverage credit to the users associated with client devices 102 via the credit redemption payment client 104 as well as the redemption of the food and beverage credit by the users via the credit redemption payment client 104. In one example, the amount of food and beverage credit can be obtained by agents of the credit redemption payment server system 106 at a discount from its face value (e.g., $0.50 for the $1.00 credit) and sold back to the consumers (e.g., the users of the credit redemption payment client 104 of the client devices 102) at a higher price (e.g., $0.80 for the $1.00 credit).

Each credit redemption payment client 104 is communicatively coupled to other instances of the credit redemption payment client 104 (e.g., hosted on respective other client devices 102), a credit redemption payment server system 106 and POS system 108 via a network 110 (e.g., the Internet) or using Applications Program Interfaces (APIs).

A credit redemption payment client 104 is able to communicate and exchange data with other messaging clients 104 and with the credit redemption payment server system 106 via the network 110. The data exchanged between messaging clients 104, and between a credit redemption payment client 104 and the credit redemption payment server system 106, includes functions (e.g., commands to invoke functions) as well as payload data (e.g., text, messages and associated content, credit redemption, credit purchase, etc.).

The credit redemption payment server system 106 provides server-side functionality via the network 110 to a particular credit redemption payment client 104. While certain functions of the system 100 are described herein as being performed by either a credit redemption payment client 104 or by the credit redemption payment server system 106, the location of certain functionality either within the credit redemption payment client 104 or the credit redemption payment server system 106 may be a design choice. For example, it may be technically preferable to initially deploy certain technology and functionality within the credit redemption payment server system 106 but to later migrate this technology and functionality to the credit redemption payment client 104 where a client device 102 has sufficient processing capacity.

The credit redemption payment server system 106 supports various services and operations that are provided to the credit redemption payment client 104. Such operations include transmitting data to, receiving data from, and processing data generated by the credit redemption payment client 104. This data may include message content, credit redemption, credit purchase, as examples. Data exchanges within the system 100 are invoked and controlled through functions available via user interfaces (UIs) of the credit redemption payment client 104.

Turning now specifically to the credit redemption payment server system 106, an Application Program Interface (API) server 114 is coupled to, and provides a programmatic interface to, application servers 112. The application servers 112 are communicatively coupled to a database server 118, which facilitates access to a database 120 that stores data associated with messages processed by the application servers 112. Similarly, a web server 122 is coupled to the application servers 112, and provides web-based interfaces to the application servers 112. To this end, the web server 122 processes incoming network requests over the Hypertext Transfer Protocol (HTTP) and several other related protocols.

The Application Program Interface (API) server 114 receives and transmits message data (e.g., commands and message payloads) between the client device 102 and the application servers 112. Specifically, the Application Program Interface (API) server 114 provides a set of interfaces (e.g., routines and protocols) that can be called or queried by the credit redemption payment client 104 in order to invoke functionality of the application servers 112. The Application Program Interface (API) server 114 exposes various functions supported by the application servers 112, including account registration, login functionality, credit redemption, and credit purchase; the sending of messages, via the application servers 112, from a particular credit redemption payment client 104 to another credit redemption payment client 104; and the sending of data related to credit redemption or credit purchase or payments to a shared invoice between a credit redemption payment client 104 and a credit redemption payment server 116.

The application servers 112 host a number of server applications and subsystems, including for example a credit redemption payment server 116. The credit redemption payment server 116 implements, for example, the near real-time updates to user interfaces being displayed on client devices 102 as part of the credit redemption payment process. Specifically, the user interfaces can include near real-time updates to the remaining amounts due based on the redeemed credits or other payments made via the credit redemption payment client 104 on other client devices 102 on the same invoice as well as near real-time updates to the selectable items associated with amounts of additional tips invoices based on the amount of tip paid by other users via the credit redemption payment client 104 on other client devices 102 on the invoice or the amount of automatic gratuity applied to the invoice.

The credit redemption payment server 116 can further implement, for example, the process of identifying the items in the invoices that can be paid using the food and beverage credit and identifying the items in the invoices that are to be paid using other types of tender (e.g., cash, credit card, etc.). The credit redemption payment server 116 can further cause user interfaces to be displayed that provides the details of the invoice including the items paid by food and beverage credit and the items to be paid by cash or credit card. As further described below, the credit redemption payment server 116 can implement other functions related to the credit redemption payment process. Other processor and memory intensive processing of data may also be performed server-side by the credit redemption payment server 116, in view of the hardware requirements for such processing.

### Data Architecture

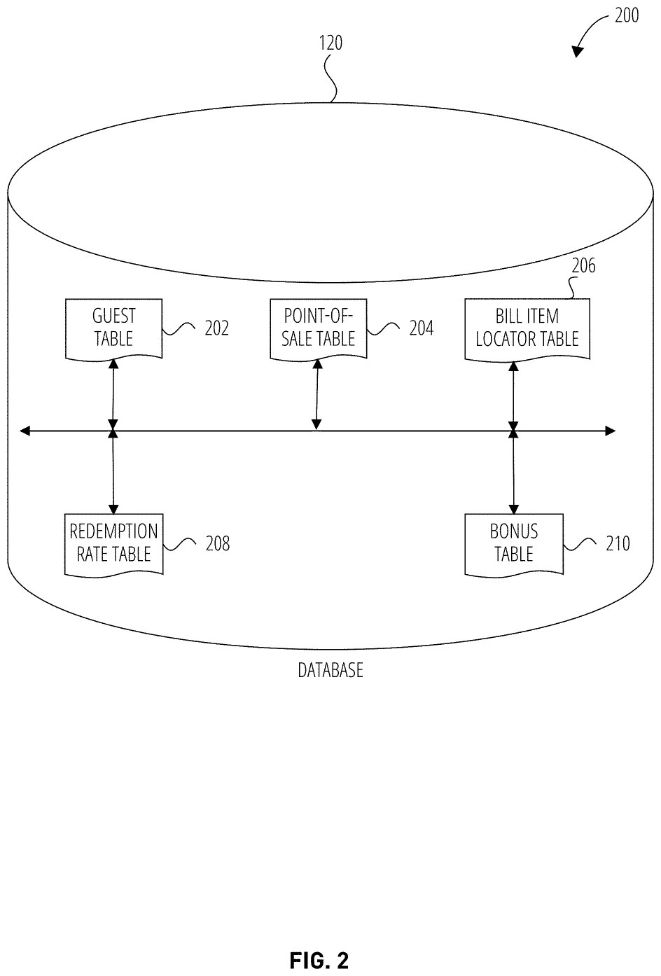

FIG. 2 is a schematic diagram illustrating data structures 200, which may be stored in the database 120 of the credit redemption payment server system 106, according to certain examples. While the content of the database 120 is shown to comprise a number of tables, it will be appreciated that the data could be stored in other types of data structures (e.g., as an object-oriented database). As shown in FIG. 2, the database 120 includes guest table 202, point-of-sale table 204, bill item locator table 206, redemption rate table 208, and bonus table 210.

The guest table 202 stores data that includes information associated with users using credit redemption payment clients 104 and purchasing and redeeming credits from the credit redemption payment server system 106. The guest table 202 can store for each user, for example, a user name, telephone number, address, settings (e.g., notification and privacy settings), as well as credit card information. The guest table 202 can also store, for each user, a remaining amount of credit based on the amount of credit that is purchased and redeemed by the user.

The point-of-sale table 204 stores data related to the hospitality establishments associated with the POS systems 108. The data in the point-of-sale table 204 can include business name, telephone number, address, type of hospitality establishment, details on the financing deals associated with the hospitality establishment (e.g., loan amount, amount of food and beverage credit provided to the credit redemption payment server system 106), the amount of credit sold and redeemed, etc.

The bill item locator table 206 stores data such as, for example, strings, data type, properties, labels, and patterns that are used to identify line items in an invoice that cannot be paid for using the food and beverage credit. For example, line items that cannot be paid for using the credit include delivery fees, automatic gratuity, service charges, wellness (or healthcare related or COVID) charges, etc.

The redemption rate table 208 stores data used to monitor the redemption rate of the food and beverage credit for each of the hospitality establishments associated with POS systems 108. For example, the redemption rate table 208 stores the total amount of credit sold for each hospitality establishment and the total amount of credit redeemed by users for each hospitality establishment. In one example, the redemption rate table 208 can also store data associated with the users in a guest ledger or credit ledger. This data can further include the credit card information on file for each of the users, the discounts received by each of the users, the existing payment methods used to reduce for the total due, etc.

The bonus table 210 stores data used to compute the bonus offers related to the sales of the food and beverage credit for each of the hospitality establishments associated with POS systems 108. For example, the bonus table 210 can store the current bonus offers that are being sold to the users via the credit redemption payment clients 104 for each of the hospitality establishments associated with POS systems 108. A bonus offer can be, for instance, an offer to purchase a higher value of food and beverage credit (e.g., $250) at restaurant A in exchange for less money (e.g., $150). In one example, the bonus table 210 can also store data associated with the users in the guest ledger or credit ledger such as the bonus offers that were received and used by each of the users.

Although the described flowcharts can show operations as a sequential process, many of the operations can be performed in parallel or concurrently. In addition, the order of the operations may be re-arranged. A process is terminated when its operations are completed. A process may correspond to a method, a procedure, an algorithm, etc. The operations of methods may be performed in whole or in part, may be performed in conjunction with some or all of the operations in other methods, and may be performed by any number of different systems, such as the systems described herein, or any portion thereof, such as a processor included in any of the systems.

### Credit Redemption Payment Process

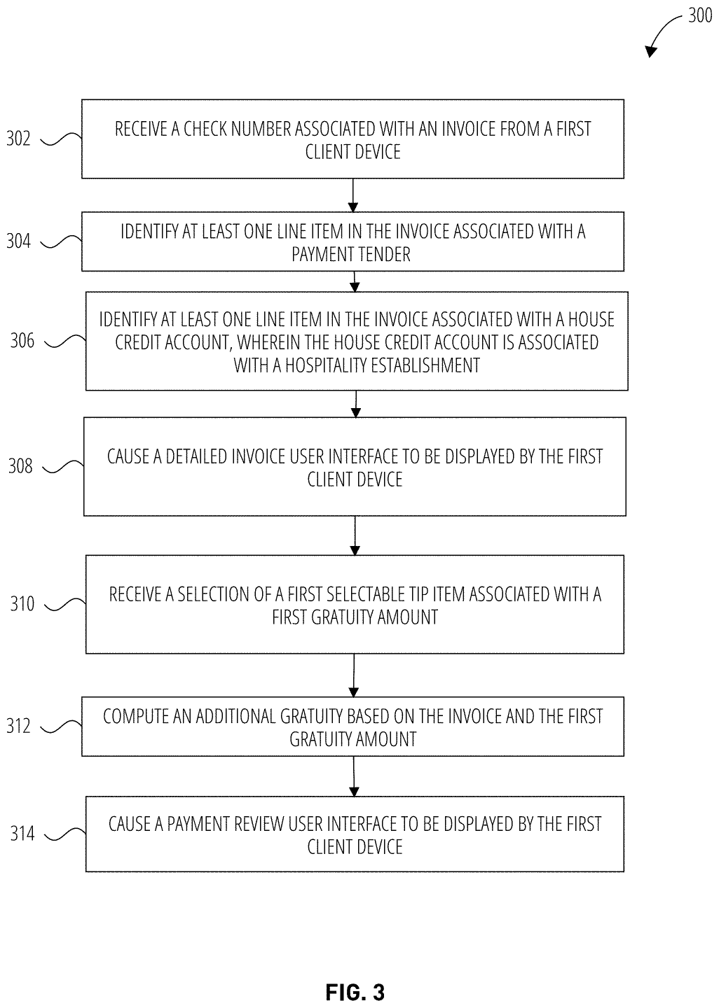

FIG. 3 is a flowchart for a credit redemption payment process 300, in accordance with some embodiments. In one example, the processor in the client device 102, the processor in the credit redemption payment server system 106 or any combination thereof, can perform the operations in process 300.

In operation 302, the processor receives a check number associated with an invoice from a first client device.

In operation 304, the processor identifies at least one line item in the invoice associated with a payment tender. For example, the at least one line item included in the invoice associated with the payment tender can be a delivery charge, a service charge, a wellness charge, or an automatic gratuity. Payment tender can include credit cards, debit cards, cash, etc. In one example, the processor can identify the delivery charge, the service charge, the wellness charge, or the automatic gratuity using classifiers, strings of text, labels, data type in a data structure, or patterns.

In one example, the processor can identify the delivery charge, the service charge, the wellness charge, or the automatic gratuity by determining whether the data type of the item or the name of the item includes the text or a portion of the text: “service”, “gratuity”, “auto”, “charge”, “tip”, “fee”, “suggested”, or “charge”. Data type of the item is a data type in the structure and the automatic gratuity, for example, can be a specific data type in some points-of-sale (POS) systems. The different charges such as the delivery charge, the service charge, the wellness charge, and the automatic gratuity may have classifiers or strings of text as labels. The processor can analyze the items to form patterns in the strings or labels that represent these charges. In one example, the processor can identify a delivery fee in the invoice when an item is associated with a delivery data type (e.g., a data type that includes the text “delivery”). The processor can further identify a service fee if the data type includes the text “service”.

The processor can further identify the delivery charge, the service charge, the wellness charge, and automatic gratuity based on the amount of the charges. For example, if the amount of the item is less than a predetermined percentage of the invoice (e.g., less than or equal to 10%), the processor can identify the item as the delivery charge, the service charge, the wellness charge, or the automatic gratuity.

In operation 306, the processor identifies at least one line item in the invoice associated with a house credit account that is associated with a hospitality establishment. For example, the line items associated with charges for food and beverage sold by the hospitality establishment can be associated with the house credit account.

In operation 308, the processor causes a detailed invoice user interface to be displayed by the first client device. The detailed invoice user interface comprises, for example, a payment tender amount due based on the at least one line item associated with the payment tender, a house credit amount due based on the at least one line item associated with the house credit account, and a plurality of selectable tip items associated with a plurality of gratuity amounts to be added to the invoice. The detailed invoice user interface can also include a list of the individual charges in an itemized receipt format. For example, the detailed invoice user interface can include a list of the items that were purchased at the hospitality establishment (e.g., restaurant). The list of items purchased at a restaurant for example can include the different beverages, appetizers, main plates or entrees, desserts, etc. Each of the items in the list can also include the price of the item. In one example, the items in the list can also include line items for a delivery charge, a service charge, a wellness charge, or an automatic gratuity.

In one example, the plurality of selectable tip items associated with a plurality of gratuity amounts can be automatically generated by the processor to account for charges that were already added to the invoice such as the delivery charge, the service charge, the wellness charge, or the automatic gratuity. For example, if the automatic gratuity is already set at 9%, rather than causing the plurality of selectable tip items associated with a plurality of gratuity amounts such as 18%, 20%, 22%, 25%, the processor can cause the plurality of selectable tip items to be associated with gratuity amounts such as 9%, 11%, 13%, and 16%, for example.

In operation 310, the processor receives a selection of a first selectable tip item associated with a first gratuity amount. The plurality of selectable tip items can include the first selectable tip item and the plurality of gratuity amounts can include the first gratuity amount.

In operation 312, the processor computes an additional gratuity based on the invoice and the first gratuity amount. In one example, if the user selects the first selectable tip item that corresponds to 20%, the first gratuity amount is 20% of the bill amount in the invoice.

In operation 314, the processor causes a payment review user interface to be displayed by the first client device that comprises a payment tender charge based on the additional gratuity and the payment tender amount due and a house credit account charge based on the house credit amount due. The payment review user interface can also comprise an amount of house credit remaining in the house credit account associated with the first client device.

In one example, the processor can determine that the invoice is an invoice that is split between a plurality of users, for example, users associated with the first client device and a second client device. The bill split can be initiated for example by a POS system 108 or by the first client device or the second client device.

In this example, the processor can receive a partial payment of the invoice from the second client device, and cause the detailed invoice user interface displayed by the first client device to be updated in near real-time. The updated detailed invoice user interface can include an updated payment tender amount, an updated house credit amount due, or an updated plurality of selectable tip items. The updated payment tender amount, the updated house credit amount due, or the updated plurality of selectable tip items can be updated based on the partial payment from the second client device. For example, if the second client device made a payment for all the gratuity (e.g., 20%), the updated detailed invoice user interface can include a decreased amount in the updated payment tender amount or decrease the gratuity values that are included in the updated plurality of selectable tip items in near real-time for the first user to review on his first client device.

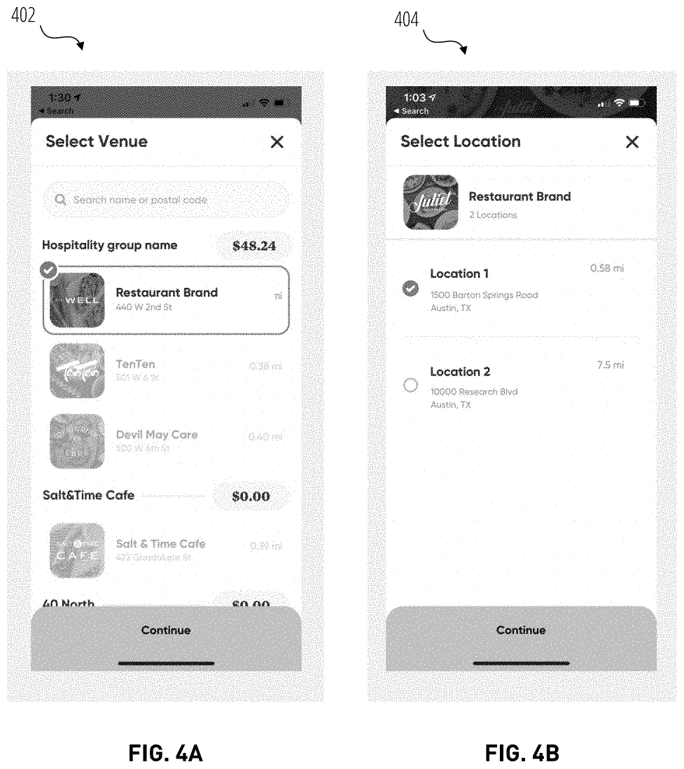

FIG. 4A-4B illustrate examples of user interfaces caused to be displayed by the client device 102 during the credit redemption payment process in accordance with one embodiment.

FIG. 4A illustrates an example of the venue selection user interface to be displayed by the first client device 102. In one embodiment, the credit redemption payment server system 106 receives the location of the client device 102 and identifies a point-of-sale (POS) system associated with the hospitality establishment based on the location of the first client device. The credit redemption payment server system 106 can cause the client device 102 to display the venue selection user interface 402 which includes a list of the hospitality establishments that are proximate to the client device 102. Each of the elements in the list of the hospitality establishments can be selectable items. In some embodiments, the user of the client device 102 can select the selectable item associated with the hospitality establishment where he wishes to use his house credit account to pay for invoice items.

FIG. 4B illustrates another venue selection user interface 404 which includes a list of different locations associated with the hospitality establishment. When more than one location exists, the user can be shown this venue selection user interface 404 to select the location where he wishes to use his house credit account to pay for invoice items.

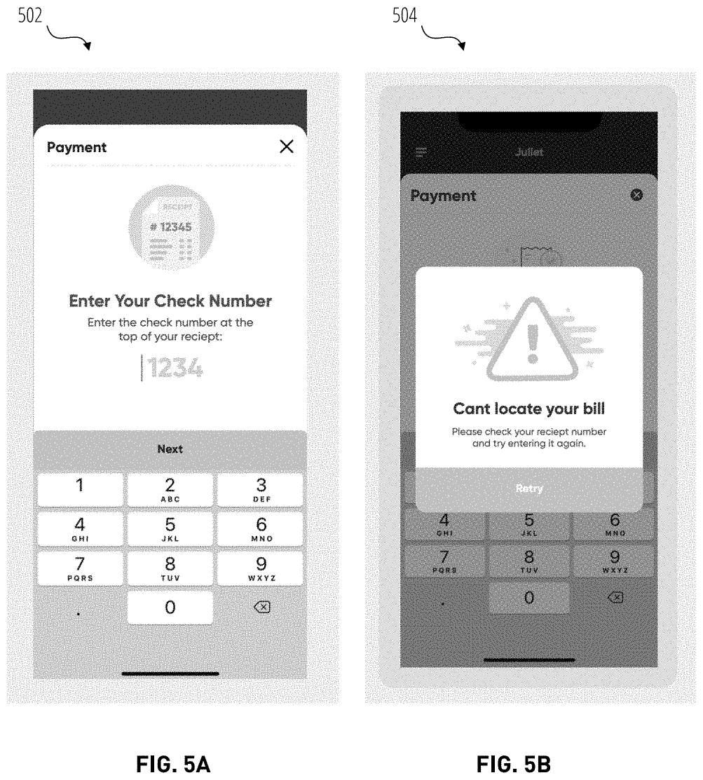

FIG. 5A illustrates an example of a check request user interface 502 displayed by the client device 102 during the credit redemption payment process in accordance with one embodiment. In one example, the credit redemption payment server system 106 causes the check request user interface 502 to be displayed by the firs client device 102 to prompt the user to input the check number associated with the invoice that he wishes to process using his house credit account and the credit redemption payment client 104.

FIG. 5B illustrates an example of a check request error user interface 504 that is displayed by the client device 102 during the credit redemption payment process in accordance with one embodiment when the check number entered in the check request user interface 502 was not located. The check request error user interface 504 indicates to the user to verify the check number that was previously entered and to try again.

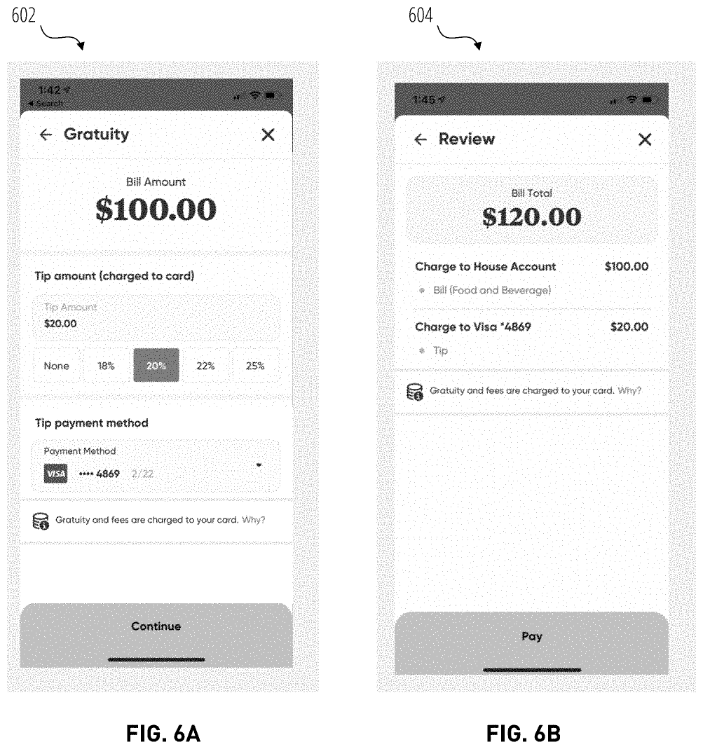

FIG. 6A illustrates an example of a detailed invoice user interface 602 that is displayed by the client device 102 during the credit redemption payment process in accordance with one embodiment. As shown in FIG. 6A, the detailed invoice user interface 602 comprises a house credit amount due based on the at least one line item associated with the house credit account (e.g., bill amount $100.00), and a plurality of selectable tip items associated with a plurality of gratuity amounts to be added to the invoice.

While not shown in FIG. 6A, the detailed invoice user interface 602 that is displayed by client device 102 can include a list of the individual charges in an itemized receipt format. For example, rather than the bill amount (e.g., bill amount $100.00), the detailed invoice user interface 602 can include a list of the items that were purchased at the hospitality establishment (e.g., restaurant). The list of items purchased at a restaurant for example can include the different beverages, appetizers, main plates or entrees, desserts, etc. Each of the items in the list can also include the price of the item. In one example, the items in the list can also include line items for a delivery charge, a service charge, a wellness charge, or an automatic gratuity.

FIG. 6B illustrates an example of a payment review user interface 604 that is displayed by the client device 102 during the credit redemption payment process in accordance with one embodiment. The payment review user interface 604 to be displayed by the first client device 102 that comprises a payment tender charge based on the additional gratuity (e.g., Tip-Charge to Visa $20.00) and a house credit account charge based on the house credit amount due (e.g., Bill (Food and Beverage) Charge to House Account $100.00).

While not shown in FIG. 6B, the payment review user interface 604 can also include line items for a delivery charge, a service charge, a wellness charge, or an automatic gratuity. In one example, the line items for a delivery charge, a service charge, a wellness charge, or an automatic gratuity appear under the payment tender charge (e.g., Charge to Visa) similar to the Tip item in FIG. 6B. In one example, each of the line items for a delivery charge, a service charge, a wellness charge, or an automatic gratuity appear on the payment review user interface 604 with the charge amount (e.g., automatic gratuity: $20.00).

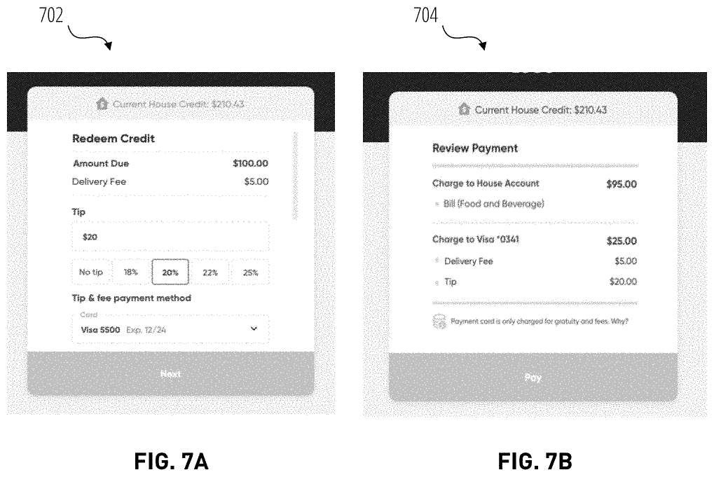

FIG. 7A illustrates another example of a detailed invoice user interface 702 that is displayed by the client device 102 during the credit redemption payment process in accordance with one embodiment. As shown in FIG. 7A, the detailed invoice user interface 702 comprises a payment tender amount due (e.g., delivery fee $25.00) based on the at least one line item associated with the payment tender, a house credit amount due (e.g., amount due $100.00) based on the at least one line item associated with the house credit account, and a plurality of selectable tip items associated with a plurality of gratuity amounts (e.g., no tip, 18%, 20%, 22%, 25%) to be added to the invoice.

FIG. 7B illustrates another example of a payment review user interface 704 that is displayed by the client device 102 during the credit redemption payment process in accordance with one embodiment. The payment review user interface 704 to be displayed by the first client device 102 that comprises a payment tender charge (e.g., Charge to Visa $25.00) based on the additional gratuity (e.g., Tip $20.00) and the payment tender amount due (e.g., Delivery Fee $5.00) and a house credit account charge (e.g., Bill (Food and Beverage) Charge to House Account $95.00) based on the house credit amount due. The payment review user interface 604 can also comprises an amount of house credit remaining in the house credit account associated with the first client device (e.g., Current House Credit: $210.43).

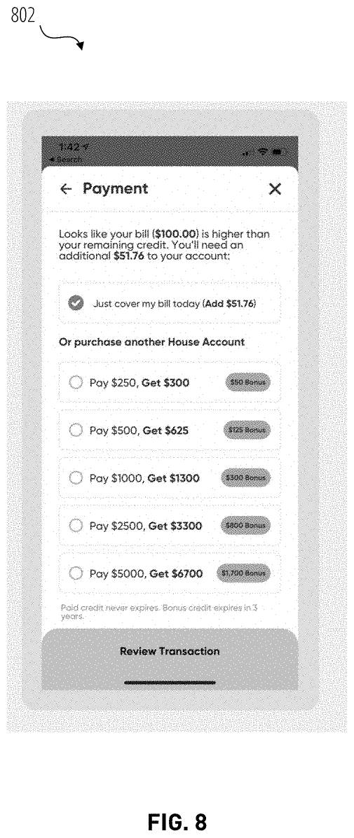

FIG. 8 illustrates an example of an upsell user interface 802 that is displayed by the client device 102 during the credit redemption payment process in accordance with one embodiment. The upsell user interface 802 is caused to be displayed by the client device 102 when the house credit account charge in the payment review user interface 604 or 704 is higher than the amount of house credit remaining in the house credit account associated with the first client device 102. The upsell user interface 802 includes a plurality of selectable items associated with bonus offer purchases of house credit to be applied to the first client device 102's account or to cover the house credit account charge shown in the payment review user interface 604 or 704.

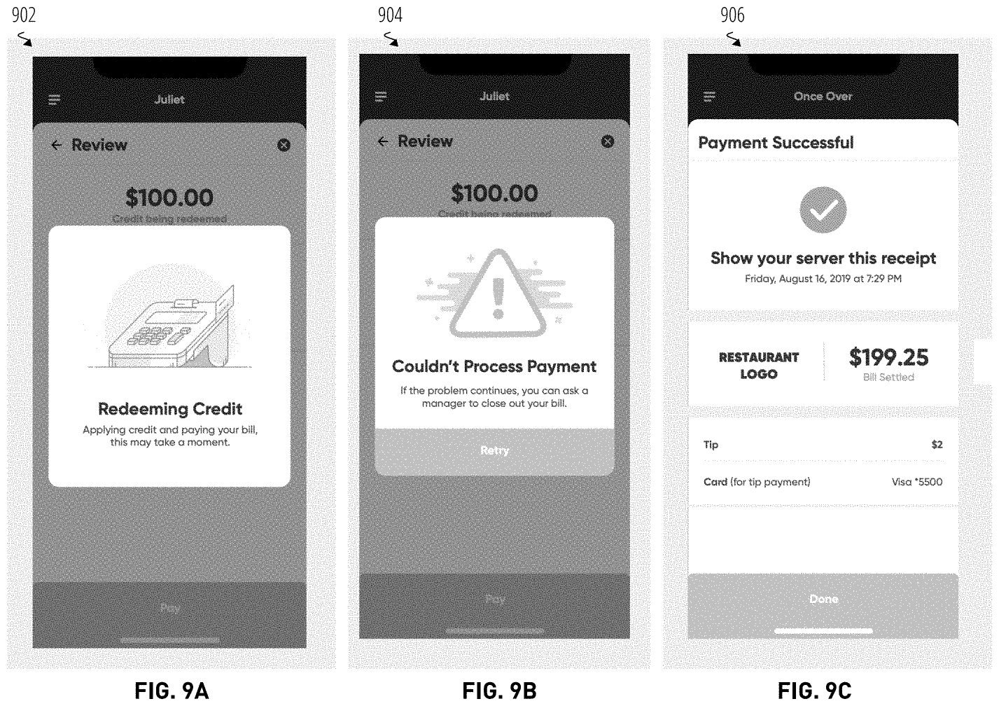

FIG. 9A illustrates an example of a redemption processing user interface 902 that is displayed by the client device 102 in accordance with one embodiment to indicate to the user that credit redemption, credit purchase or payment using payment tender is being processed.

FIG. 9B illustrates an example of a redemption error user interface 904 that is displayed by the client device 102 in accordance with one embodiment to indicate to the user that credit redemption, credit purchase or payment using payment tender could not be processed. The redemption error user interface 904 prompts the user to retry processing or ask the manager of the hospitality establishment to help close out the invoice.

FIG. 9C illustrates an example of a redemption success user interface 906 that is displayed by the client device 102 in accordance with one embodiment to indicate to the user that credit redemption, credit purchase or payment using payment tender was successfully processed.

### Machine Architecture

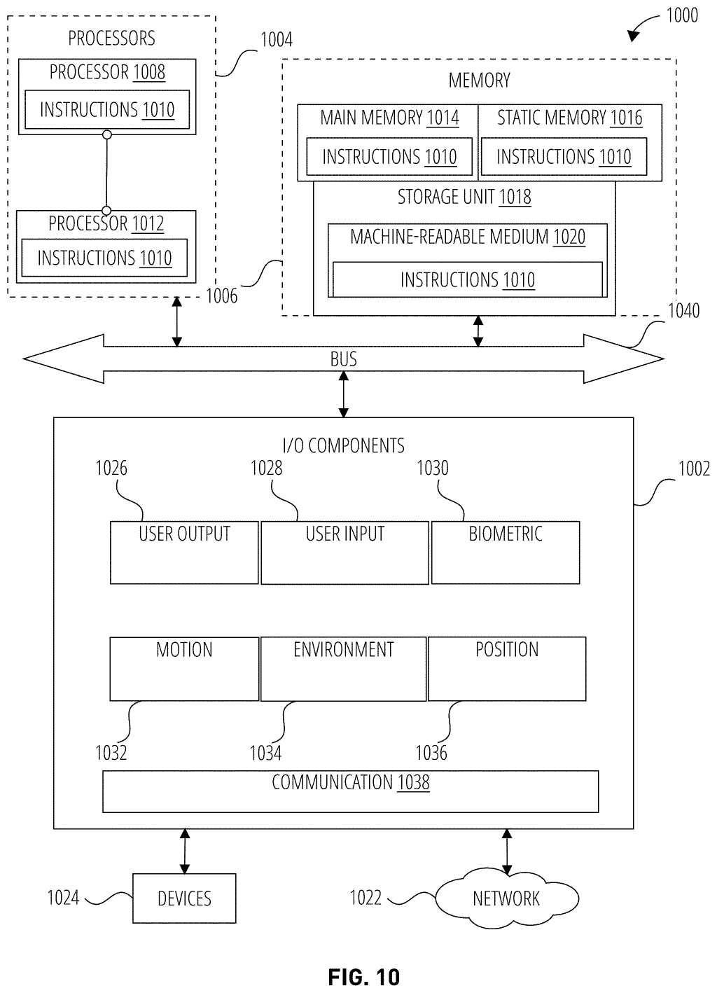

FIG. 10 is a diagrammatic representation of the machine 1000 within which instructions 1010 (e.g., software, a program, an application, an applet, an app, or other executable code) for causing the machine 1000 to perform any one or more of the methodologies discussed herein may be executed. For example, the instructions 1010 may cause the machine 1000 to execute any one or more of the methods described herein. The instructions 1010 transform the general, non-programmed machine 1000 into a particular machine 1000 programmed to carry out the described and illustrated functions in the manner described. The machine 1000 may operate as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1010, sequentially or otherwise, that specify actions to be taken by the machine 1000. Further, while only a single machine 1000 is illustrated, the term “machine” shall also be taken to include a collection of machines that individually or jointly execute the instructions 1010 to perform any one or more of the methodologies discussed herein. The machine 1000, for example, may comprise the client device 102 or any one of a number of server devices forming part of the credit redemption payment server system 106. In some examples, the machine 1000 may also comprise both client and server systems, with certain operations of a particular method or algorithm being performed on the server-side and with certain operations of the particular method or algorithm being performed on the client-side.

The machine 1000 may include processors 1004, memory 1006, and input/output I/O components 1002, which may be configured to communicate with each other via a bus 1040. In an example, the processors 1004 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1008 and a processor 1012 that execute the instructions 1010. The term “processor” is intended to include multi-core processors that may comprise two or more independent processors (sometimes referred to as “cores”) that may execute instructions contemporaneously. Although FIG. 10 shows multiple processors 1004, the machine 1000 may include a single processor with a single-core, a single processor with multiple cores (e.g., a multi-core processor), multiple processors with a single core, multiple processors with multiples cores, or any combination thereof.

The memory 1006 includes a main memory 1014, a static memory 1016, and a storage unit 1018, both accessible to the processors 1004 via the bus 1040. The main memory 1006, the static memory 1016, and storage unit 1018 store the instructions 1010 embodying any one or more of the methodologies or functions described herein. The instructions 1010 may also reside, completely or partially, within the main memory 1014, within the static memory 1016, within machine-readable medium 1020 within the storage unit 1018, within at least one of the processors 1004 (e.g., within the Processor's cache memory), or any suitable combination thereof, during execution thereof by the machine 1000.

The I/O components 1002 may include a wide variety of components to receive input, provide output, produce output, transmit information, exchange information, capture measurements, and so on. The specific I/O components 1002 that are included in a particular machine will depend on the type of machine. For example, portable machines such as mobile phones may include a touch input device or other such input mechanisms, while a headless server machine will likely not include such a touch input device. It will be appreciated that the I/O components 1002 may include many other components that are not shown in FIG. 10. In various examples, the I/O components 1002 may include user output components 1026 and user input components 1028. The user output components 1026 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1028 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1002 may include biometric components 1030, motion components 1032, environmental components 1034, or position components 1036, among a wide array of other components. For example, the biometric components 1030 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1032 include acceleration sensor components (e.g., accelerometer), gravitation sensor components, rotation sensor components (e.g., gyroscope).

The environmental components 1034 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the client device 102 may have a camera system comprising, for example, front cameras on a front surface of the client device 102 and rear cameras on a rear surface of the client device 102. The front cameras may, for example, be used to capture still images and video of a user of the client device 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the client device 102 may also include a 360° camera for capturing 360° photographs and videos.

Further, the camera system of a client device 102 may include dual rear cameras (e.g., a primary camera as well as a depth-sensing camera), or even triple, quad or penta rear camera configurations on the front and rear sides of the client device 102. These multiple cameras systems may include a wide camera, an ultra-wide camera, a telephoto camera, a macro camera, and a depth sensor, for example.

The position components 1036 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1002 further include communication components 1038 operable to couple the machine 1000 to a network 1022 or devices 1024 via respective coupling or connections. For example, the communication components 1038 may include a network interface Component or another suitable device to interface with the network 1022. In further examples, the communication components 1038 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1024 may be another machine or any of a wide variety of peripheral devices (e.g., a peripheral device coupled via a USB).

Moreover, the communication components 1038 may detect identifiers or include components operable to detect identifiers. For example, the communication components 1038 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1038, such as location via Internet Protocol (IP) geolocation, location via Wi-Fi® signal triangulation, location via detecting an NFC beacon signal that may indicate a particular location, and so forth.

The various memories (e.g., main memory 1014, static memory 1016, and memory of the processors 1004) and storage unit 1018 may store one or more sets of instructions and data structures (e.g., software) embodying or used by any one or more of the methodologies or functions described herein. These instructions (e.g., the instructions 1010), when executed by processors 1004, cause various operations to implement the disclosed examples.

The instructions 1010 may be transmitted or received over the network 1022, using a transmission medium, via a network interface device (e.g., a network interface component included in the communication components 1038) and using any one of several well-known transfer protocols (e.g., hypertext transfer protocol (HTTP)). Similarly, the instructions 1010 may be transmitted or received using a transmission medium via a coupling (e.g., a peer-to-peer coupling) to the devices 1024.

### Software Architecture

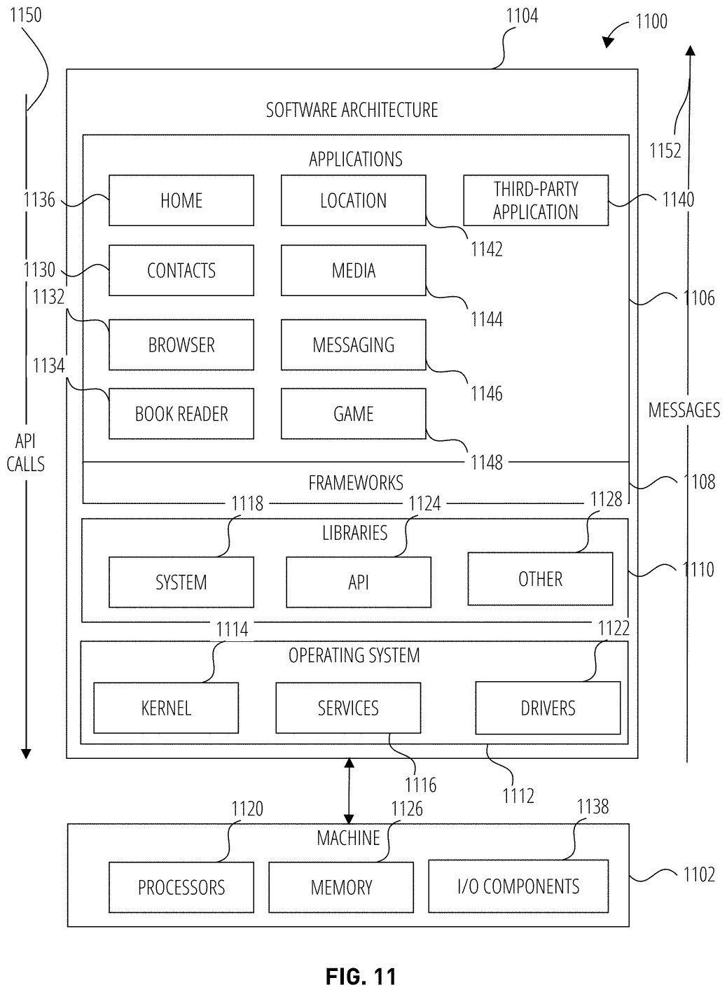

FIG. 11 is a block diagram 1100 illustrating a software architecture 1104, which can be installed on any one or more of the devices described herein. The software architecture 1104 is supported by hardware such as a machine 1102 that includes processors 1120, memory 1126, and I/O components 1138. In this example, the software architecture 1104 can be conceptualized as a stack of layers, where each layer provides a particular functionality. The software architecture 1104 includes layers such as an operating system 1112, libraries 1110, frameworks 1108, and applications 1106. Operationally, the applications 1106 invoke API calls 1150 through the software stack and receive messages 1152 in response to the API calls 1150.

The operating system 1112 manages hardware resources and provides common services. The operating system 1112 includes, for example, a kernel 1114, services 1116, and drivers 1122. The kernel 1114 acts as an abstraction layer between the hardware and the other software layers. For example, the kernel 1114 provides memory management, processor management (e.g., scheduling), component management, networking, and security settings, among other functionalities. The services 1116 can provide other common services for the other software layers. The drivers 1122 are responsible for controlling or interfacing with the underlying hardware. For instance, the drivers 1122 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1110 provide a common low-level infrastructure used by the applications 1106. The libraries 1110 can include system libraries 1118 (e.g., C standard library) that provide functions such as memory allocation functions, string manipulation functions, mathematic functions, and the like. In addition, the libraries 1110 can include API libraries 1124 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1110 can also include a wide variety of other libraries 1128 to provide many other APIs to the applications 1106.

The frameworks 1108 provide a common high-level infrastructure that is used by the applications 1106. For example, the frameworks 1108 provide various graphical user interface (GUI) functions, high-level resource management, and high-level location services. The frameworks 1108 can provide a broad spectrum of other APIs that can be used by the applications 1106, some of which may be specific to a particular operating system or platform.

In an example, the applications 1106 may include a home application 1136, a contacts application 1130, a browser application 1132, a book reader application 1134, a location application 1142, a media application 1144, a messaging application 1146, a game application 1148, and a broad assortment of other applications such as a third-party application 1140. The applications 1106 are programs that execute functions defined in the programs. Various programming languages can be employed to create one or more of the applications 1106, structured in a variety of manners, such as object-oriented programming languages (e.g., Objective-C, Java, or C++) or procedural programming languages (e.g., C or assembly language). In a specific example, the third-party application 1140 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1140 can invoke the API calls 1150 provided by the operating system 1112 to facilitate functionality described herein.

### Glossary

“Carrier signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

“Client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors 1004 or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers to a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

What is claimed is:

1. A method comprising:
receiving, by a processor, a check number associated with an invoice from a first client device;
identifying at least one line item in the invoice associated with a payment tender;
identifying at least one line item in the invoice associated with a house credit account, wherein the house credit account is associated with a hospitality establishment;
causing a detailed invoice user interface to be displayed by the first client device, wherein the detailed invoice user interface comprises:
a payment tender amount due based on the at least one line item associated with the payment tender,
a house credit amount due based on the at least one line item associated with the house credit account, and
plurality of selectable tip items associated with a plurality of gratuity amounts to be added to the invoice;
receiving a selection of a first selectable tip item associated with a first gratuity amount, wherein the plurality of selectable tip items includes the first selectable tip item and the plurality of gratuity amounts includes the first gratuity amount;
computing an additional gratuity based on the invoice and the first gratuity amount; and
causing a payment review user interface to be displayed by the first client device, wherein the payment review user interface comprises:
a payment tender charge based on the additional gratuity and the payment tender amount due, and
a house credit account charge based on the house credit amount due.

2. The method of claim 1, further comprising:
receiving a location of the first client device; and
identifying a point-of-sale (POS) system associated with the hospitality establishment based on the location of the first client device; and
causing a venue selection user interface to be displayed by the first client device that includes a selectable item associated with the hospitality establishment.

3. The method of claim 1, further comprising:
causing a check request user interface to be displayed by the first client device.

4. The method of claim 1, further comprising:
determining that the invoice is associated with the first client device and a second client device;
receiving a partial payment of the invoice from the second client device; and
causing the detailed invoice user interface displayed by the first client device to be updated in near real-time, wherein the updated detailed invoice user interface includes an updated payment tender amount, an updated house credit amount due, or an updated plurality of selectable tip items.

5. The method of claim 4, wherein the updated payment tender amount, the updated house credit amount due, or the updated plurality of selectable tip items are updated based on the partial payment from the second client device.

6. The method of claim 1, wherein the at least one line item included in the invoice associated with the payment tender comprises a delivery charge, a service charge, a wellness charge, or an automatic gratuity.

7. The method of claim 6, wherein identifying the at least one line item included in the invoice associated with the payment tender comprises:
identifying the delivery charge, the service charge, the wellness charge, or the automatic gratuity using classifiers, strings of text, labels, data type in a data structure, or patterns.

8. The method of claim 1, wherein the payment review user interface comprises an amount of house credit remaining in the house credit account associated with the first client device.

9. A system comprising:
a processor; and
a memory storing instructions that, when executed by the processor, causes the system to perform operations comprising:
receiving a check number associated with an invoice from a first client device;
identifying at least one line item in the invoice associated with a payment tender;
identifying at least one line item in the invoice associated with a house credit account, wherein the house credit account is associated with a hospitality establishment;
causing a detailed invoice user interface to be displayed by the first client device, wherein the detailed invoice user interface comprises:
a payment tender amount due based on the at least one line item associated with the payment tender,
a house credit amount due based on the at least one line item associated with the house credit account, and
plurality of selectable tip items associated with a plurality of gratuity amounts to be added to the invoice;
receiving a selection of a first selectable tip item associated with a first gratuity amount, wherein the plurality of selectable tip items includes the first selectable tip item and the plurality of gratuity amounts includes the first gratuity amount;
computing an additional gratuity based on the invoice and the first gratuity amount; and
causing a payment review user interface to be displayed by the first client device, wherein the payment review user interface comprises:
a payment tender charge based on the additional gratuity and the payment tender amount due, and
a house credit account charge based on the house credit amount due.

10. The system of claim 9, wherein the system to perform operations further comprising:
receiving a location of the first client device; and
identifying a point-of-sale (POS) system associated with the hospitality establishment based on the location of the first client device; and
causing a venue selection user interface to be displayed by the first client device that includes a selectable item associated with the hospitality establishment.

11. The system of claim 9, wherein the system to perform operations further comprising:
causing a check request user interface to be displayed by the first client device.

12. The system of claim 9, wherein the system to perform operations further comprising:
determining that the invoice is associated with the first client device and a second client device;
receiving a partial payment of the invoice from the second client device; and
causing the detailed invoice user interface displayed by the first client device to be updated in near real-time, wherein the updated detailed invoice user interface includes an updated payment tender amount, an updated house credit amount due, or an updated plurality of selectable tip items.

13. The system of claim 12, wherein the updated payment tender amount, the updated house credit amount due, or the updated plurality of selectable tip items are updated based on the partial payment from the second client device.

14. The system of claim 9, wherein the at least one line item included in the invoice associated with the payment tender comprises a delivery charge, a service charge, a wellness charge, or an automatic gratuity.

15. The system of claim 14, wherein identifying the at least one line item included in the invoice associated with the payment tender comprises:
identifying the delivery charge, the service charge, the wellness charge, or the automatic gratuity using classifiers, strings of text, labels, data type in a data structure, or patterns.

16. The system of claim 9, wherein the payment review user interface comprises an amount of house credit remaining in the house credit account associated with the first client device.

17. A non-transitory computer-readable storage medium including instructions that, when processed by a processor, causes the processor to perform operations comprising:
receiving a check number associated with an invoice from a first client device;
identifying at least one line item in the invoice associated with a payment tender;
identifying at least one line item in the invoice associated with a house credit account, wherein the house credit account is associated with a hospitality establishment;
causing a detailed invoice user interface to be displayed by the first client device, wherein the detailed invoice user interface comprises:
a payment tender amount due based on the at least one line item associated with the payment tender,
a house credit amount due based on the at least one line item associated with the house credit account, and
plurality of selectable tip items associated with a plurality of gratuity amounts to be added to the invoice;
receiving a selection of a first selectable tip item associated with a first gratuity amount, wherein the plurality of selectable tip items includes the first selectable tip item and the plurality of gratuity amounts includes the first gratuity amount;
computing an additional gratuity based on the invoice and the first gratuity amount; and
causing a payment review user interface to be displayed by the first client device, wherein the payment review user interface comprises:
a payment tender charge based on the additional gratuity and the payment tender amount due, and
a house credit account charge based on the house credit amount due.

18. The non-transitory computer-readable storage medium of claim 17, wherein the processor to perform operations further comprising:
determining that the invoice is associated with the first client device and a second client device;
receiving a partial payment of the invoice from the second client device; and
causing the detailed invoice user interface displayed by the first client device to be updated in near real-time, wherein the updated detailed invoice user interface includes an updated payment tender amount, an updated house credit amount due, or an updated plurality of selectable tip items.

19. The non-transitory computer-readable storage medium of claim 18, wherein the updated payment tender amount, the updated house credit amount due, or the updated plurality of selectable tip items are updated based on the partial payment from the second client device.

20. The non-transitory computer-readable storage medium of claim 18,
wherein the at least one line item included in the invoice associated with the payment tender comprises a delivery charge, a service charge, a wellness charge, or an automatic gratuity, and
wherein identifying the at least one line item included in the invoice associated with the payment tender comprises:
identifying the delivery charge, the service charge, the wellness charge, or the automatic gratuity using classifiers, strings of text, labels, data type in a data structure, or patterns.
